(19) United States
(12) Patent Application Publication
(10) Pub. No.: US 2004/0173431 A1
(43) Pub. Date: Sep. 9, 2004

(54) Vehicle brake pedal interlock for heavy vehicle neutral to engaged gear shift

(76) Inventors: James Henry DeVore, Laurinburg, NC (US); Robert Anthony Sayman, Laurinburg, NC (US); Ronald Peter Muetzel, Pinehurst, NC (US); Erwin Werner, Friedrichshafen (DE)

Correspondence Address: CARLSON, GASKEY & OLDS, P.C., 400 WEST MAPLE ROAD, SUITE 350, BIRMINGHAM, MI, 48009, US

(21) Appl. No.: 10/382,974

(22) Filed: Mar. 6, 2003

(51) Int. Cl. B60K 41/26

(52) U.S. Cl. 192/220.2; 192/222

(57) ABSTRACT

A heavy vehicle transmission is provided with an interlock that prevents movement from neutral into an engaged speed ratio if the vehicle is under start from stop conditions. The interlock ensures that the operator does desire to engage a gear prior to effecting the engagement. The method is also incorporated into a control for the transmission. The method and control are most preferably incorporated into a type of automatic transmission which has an automatic clutch that does not require any operator input.

### BACKGROUND OF THE INVENTION

This invention relates to an interlock between the application of the vehicle brakes, and the movement of a heavy vehicle transmission from a neutral position to an engaged position at start-up.

Heavy vehicles are typically provided with a transmission allowing the operator to select several speed ratios between a drive input from the engine and an output speed. Historically, most heavy vehicle transmissions were manual transmissions. The operator would manipulate a shift lever to engage the desired gears in the transmission to provide a desired speed ratio.

More recently, the heavy vehicle operator is provided with assistance in achieving changes in speed ratios, and even assistance in selecting an appropriate speed ratio. As one example, automated shift transmissions are known wherein the operator merely selects a desire to change the engaged speed ratio, and appropriate drive actuators and controls actually move the transmission elements to achieve the desired speed ratio. Such systems are known as “shift by wire” transmissions. A shift by wire transmission is typically provided with a rocking input element that is moved forwardly or rearwardly to indicate a desire for an upshift or a downshift. In many of these systems, when the truck is at rest, the transmission is in neutral. That is, when the heavy vehicle is stopped, typically the transmission moves to a neutral condition.

When the operator again wishes to drive the heavy vehicle, the transmission is moved from neutral to a starting gear. Typically, this movement is begun when the operator rocks the selection lever.

Further, and historically, heavy vehicles have been provided with a manually actuatable clutch that is depressed to assist movement for any gear change. However, more recently, automatic clutches have been provided which require no operator input.

One further feature in modern heavy vehicle transmissions is the increased usage of automatic transmissions. As known, an automatic transmission selects the optimum gear speed for particular driving conditions. Further, hybrids combining both automatic and manual abilities are also beginning to achieve increased popularity in the heavy vehicle transmission market.

As mentioned, in many of these transmissions, the operator does indicate a desire to move from neutral into a starting gear at start conditions by rocking the input lever. It would be desirable to have an interlock which prevents movement from neutral to an engaged gear when the operator indicates a desire for a start from stop condition unless the vehicle brake is engaged indicating the operator does in fact want the vehicle to begin moving to drive condition. This would eliminate the possibility of the operator inadvertently rocking the input lever prior to being ready to begin driving the vehicle.

### SUMMARY OF THE INVENTION

In a preferred embodiment of this invention, a software interlock is provided in the control. If the vehicle brake is not engaged, and a request for movement from neutral into a drive gear is received, the gear will not be engaged if the vehicle is at a condition consistent with starts from stop. That is, if the vehicle is moving below a predetermined speed, movement from neutral to a particular drive gear will not be achieved unless the vehicle brake is engaged.

Appropriate software to achieve these features is preferably included into the drive control for the transmission.

These and other features of the present invention can be best understood from the following specification and drawings, the following of which is a brief description.

### BRIEF DESCRIPTION OF THE DRAWINGS

FIG. 1 is a schematic view of a vehicle having an automated transmission.

FIG. 2 is a flowchart of the inventive method.

### DETAILED DESCRIPTION OF THE PREFERRED EMBODIMENT

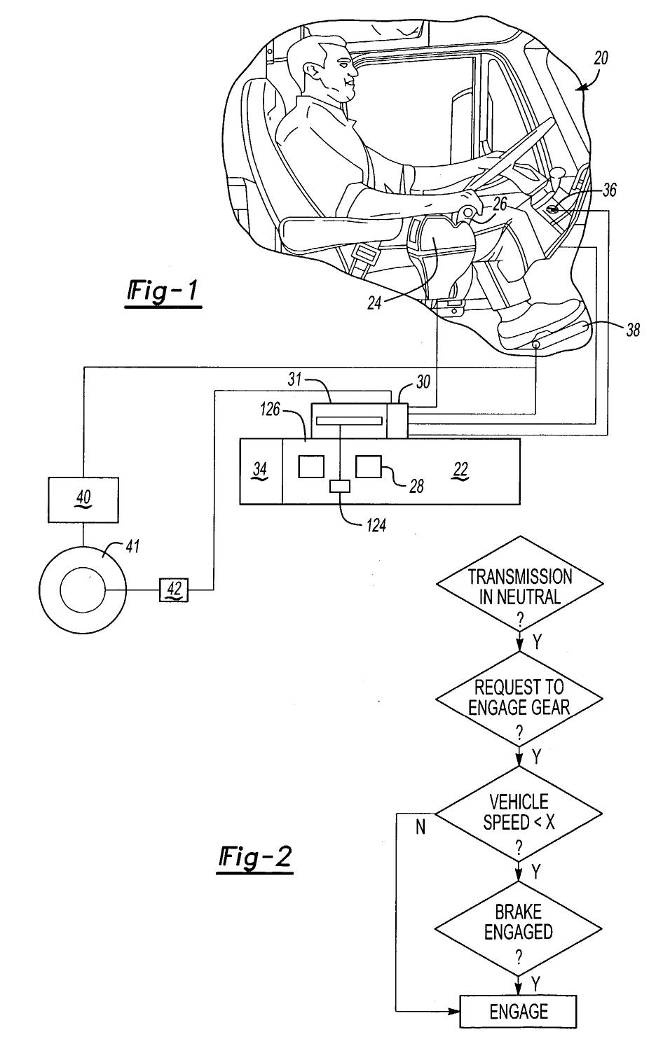

FIG. 1 schematically shows a heavy vehicle 20 incorporating a transmission 22. As known, transmission 22 includes shift element 124 that selectively moves to engage plural drive gears 126 and 28 and achieve various speed ratios. The element 124 is shown schematically in a “neutral” position at which neither gear 126 or 28 is engaged. As is further known, a shift actuator 31 and control 30 may move the element 24 to the two engaged positions or its neutral position. Obviously, this is an extremely schematic representation of a transmission. However, this description will be sufficient such that a worker in the art can understand this invention. Further as known, a gear selection element 26 may be rocked forwardly or rearwardly within its base 24 to select a desired speed ratio change in the transmission 22. A switch or appropriate software can determine when the vehicle is in neutral.

The vehicle 20 is preferably provided with the transmission 22 of the sort that does not require the operator to engage the clutch to achieve a change in speed ratio, or to achieve movement from neutral to an engaged position. Instead, an automatic clutch 34 may be utilized. Further, the system may be provided with a control that controls an engine variable, such as fueling, to allow movement out of an engaged gear and movement into a gear to be engaged without any clutch actuation. Such systems are known. That is, the inventive method and apparatus is most preferably incorporated into a transmission which does not require manual operator control of a clutch to achieve a gear change.

Most recently, so-called hybrid transmissions including both the use of automatic and manual gear speed selections are known, and which include an automatic clutch. The automatic clutch 34 is shown schematically in this embodiment. The control for the actuator 30, or another control mounted elsewhere, controls the automatic clutch to also achieve the movement between engaged and neutral conditions. In such hybrid transmissions, the operator is provided with a switch 36, shown schematically, for selecting either manual or automatic operation.

In the prior art, if the vehicle is in neutral, and at stop conditions, the rocking of selection lever 26 is interpreted to be a desire to move from neutral into a starting gear. Various algorithms are known for selecting an appropriate starting gear, or for allowing an operator to select a desired starting gear. However, the starting gear is engaged from neutral once an indication to begin movement is received by rocking of the lever 26.

The present invention includes an interlock in the control 30 that requires the brake pedal 38 be depressed before movement from neutral into an engaged gear will be affected at a start from stop condition. As is known, when the brake pedal 38 is actuated, the service brake 40 would be engaged to prevent or retard movement of the vehicle 20.

FIG. 2 is a flowchart of the present invention. The vehicle begins in neutral. A request to engage a starting gear is received when the vehicle is in neutral, such as by rocking of the lever 26. The control software then asks if the vehicle speed is below a pre-determined maximum. As an example, if the vehicle is traveling less than 3 kilometers per hour, then the vehicle is in a start from stop condition. An appropriate speed sensor 42 is associated with the vehicle wheel 41 to provide the speed feedback to the control 30. If the vehicle is exceeding this maximum speed, then no interlock is required as the vehicle is typically already moving, and has been moving. Under such conditions, it would not be desirable to require the operator to depress the brake to move from neutral to an engaged position. However, if the speed is below this maximum, the control then asks whether the brake pedal is engaged. If the brakes are engaged, then the shift element 124 will be allowed to move to a position at which it engages a starting gear.

The present invention thus eliminates any tendency for an inadvertent rocking of lever 26 to be interpreted and relied upon to engage a gear sooner than the operator would desire.

A preferred embodiment of this invention has been disclosed. A worker of ordinary skill in the art would recognize the control and mechanical elements that form a part of this invention. Further, a worker of ordinary skill in the art would recognize that modifications may come within the scope of this invention. For that reason, the following claims should be studied to determine the true scope and content of this invention.

What is claimed is:

1. A method of engaging a gear in a heavy vehicle comprising the steps of:
(1) providing a transmission for a heavy vehicle including an automated actuator for driving transmission components between neutral and a starting gear, and providing a shift input element to allow an operator to indicate a desire to move from neutral into a starting gear at a start from stop condition; and
(2) receiving a request to move from neutral into a starting gear, and not effecting an engagement of a starting gear unless the vehicle brakes are engaged, and engaging said starting gear if it is determined that the vehicle's brakes are engaged.

2. A method as set forth in claim 1, wherein said heavy vehicle has an automatic clutch that does not require any operator input.

3. A method as set forth in claim 1, wherein said input element is a pivoting element that an operator may pivot forwardly and rearwardly to indicate a desire for a shift in gear speed.

4. A method as set forth in claim 1, wherein a brake pedal controls actuation of said brakes, and said method includes a step of determining that said brake pedal is depressed prior to effecting said engagement from neutral into an engaged gear.

5. A method as set forth in claim 1, wherein a speed sensor determines whether the speed of the heavy vehicle is below a maximum, and does not perform the method of step (2) if the vehicle speed exceeds said maximum.

6. A transmission control comprising:
a control element programmed to receive an input request from an operator and control transmission elements to move from neutral to an engaged gear, and between engageable gears, said control element further being operable to receive a signal indicative of vehicle speed and a signal indicative of actuation of a brake, said control blocking engagement of movement from neutral into a gear if said vehicle speed is less than a maximum, and said brake signal does not indicate that the brakes are engaged.

7. A transmission system comprising:
a transmission having a plurality of selectively engageable gears, and an element which can be moved to selectively engage said gears, said element being in a neutral position when a vehicle associated with said transmission is stopped;
a control for said transmission, said control being operable to receive input request signals from an operator to change speed ratios in said transmission, said control further receiving signals which indicate whether brakes associated with the vehicle are engaged, and a signal indicating a speed of said vehicle, said control further receiving signals from an operator requesting movement from neutral into an engaged position at a start from stop condition; and
said control blocking movement from neutral into an engaged gear if said vehicle is moving below a pre-determined maximum speed when a request to move from neutral into an engaged gear is received, and the brakes are not engaged.
